(19) United States
(12) Patent Application Publication
(10) Pub. No.: US 2015/0205610 A1
(43) Pub. Date: Jul. 23, 2015

(54) CONFIGURING MANAGED SYSTEMS USING ABSTRACTED FUNCTIONS

(71) Applicant: Red Hat, Inc., Raleigh, NC (US)

(72) Inventors: Stephen Gallagher, Methuen, MA (US); Jan Safranek, Brno (CZ); Michal Minar, Horni Jeleni (CZ)

(73) Assignee: Red Hat, Inc., Raleigh, NC (US)

(21) Appl. No.: 14/161,917

(22) Filed: Jan. 23, 2014

(51) Int. Cl. G06F 9/30

(52) U.S. Cl. CPC G06F 9/30181

(57) ABSTRACT

Systems and methods for configuring managed systems using abstracted functions. An example method may include: receiving a command corresponding to one or more instructions in a defined protocol, the instructions being directed to a first system and a second system, processing the command to generate the instructions, configuring a first instance of the one or more instructions with respect to the first system, configuring a second instance of the one or more instructions with respect to the second system, determining, with the processing device, an execution efficiency metric with respect to the first instance of the one or more instructions and the second instance of the one or more instructions, and providing, in view of the execution efficiency metric, at least one of the first instance of the one or more instructions to the first system or the second instance of the one or more instructions to the second system.

### TECHNICAL FIELD

Implementations of the present disclosure relate to a computing system, and more specifically, to configuring managed systems using abstracted functions.

### BACKGROUND

The Common Information Model (CIM) standard is a protocol that enables the centralized management of managed systems. The CIM specification and schema are lengthy and may be difficult to utilize for some users.

### DESCRIPTION OF DRAWINGS

The details of one or more implementations are set forth in the accompanying drawings and the description below. Other features and advantages will be apparent from the description and drawings, and from the claims.

FIG. 1 is a block diagram of a host computer system in accordance with some implementations.

FIG. 2 is a flow diagram of a method for configuring managed systems using abstracted functions in accordance with some implementations.

FIG. 3 is a schematic diagram that shows an example of a machine in the form of a computer system.

### DETAILED DESCRIPTION

The present disclosure pertains to configuring managed systems using abstracted functions.

The CIM (Common Information Model) standard is a commonly used protocol for the management of managed systems. While CIM provides considerable functionality, the size of the CIM specification makes it difficult for many users to utilize. Accordingly, described herein in various implementations are technologies that enable users (e.g., administrators of such managed systems) to utilize underlying CIM functionality using an abstraction layer that operates in relation to underlying CIM instructions. Such an abstraction layer can be employed using Python (and/or another scripting language) and can provide a considerably simplified interface for managing such systems using underlying CIM instructions. For example, a single command in Python can be provided by an administrator, and such a command can be converted into multiple underlying CIM commands that are subsequently executed at the managed system in order to achieve a particular result (e.g., partition a network disk, etc.).

Additionally, it can be appreciated that while CIM is utilized in numerous systems/environments (e.g., Windows, Linux, etc.), each system may have various aspects of the protocol (e.g., extensions, etc.) that are particular to that system. Accordingly, as described herein, using data maintained with respect to each such system, the generated CIM instructions can be further configured to be provided to a particular system. In doing so, an administrator can provide one or more commands which are converted into CIM instructions and then further configured for each respective system according to the requirements, specifications, extensions, etc., associated with such a system.

Moreover, in some scenarios one or more received commands may not specify a particular managed system to which they are directed and/or such commands may be capable of implementation/execution across multiple managed systems (e.g., in a distributed/parallel fashion). Accordingly, in scenarios in which it is determined that one system may be relatively more efficient at executing a particular set of instructions than another, such instructions can be provided to the system determined to be more efficient. In other scenarios, such as when multiple systems are determined to be relatively comparable with respect to efficiently executing a set of instructions, such instructions can be modified (e.g., where possible/appropriate) to distribute them across several of such systems, thereby further increasing the efficiency of each of the system and the execution of the instructions.

In the following description, numerous details are set forth. It will be apparent, however, to one skilled in the art, that the present disclosure may be practiced without these specific details. In some instances, well-known structures and devices are shown in block diagram form, rather than in detail, in order to avoid obscuring the present disclosure.

For brevity, simplicity and by way of example, an abstraction conversion engine, such as a service, application, etc., executing on a device or server such as a management system can perform many of the operations described herein. It is contemplated that other actors may perform some or all of the operations described herein, including various other devices and/or components described herein, including a combination thereof.

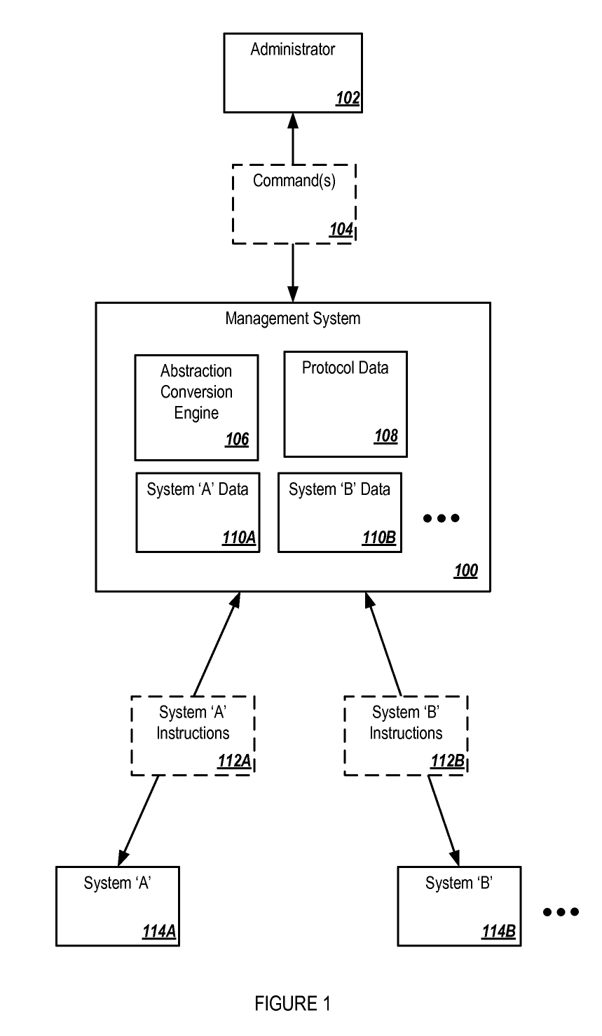

FIG. 1 is a block diagram that illustrates an example of a management system 100. Management system 100 can be a rackmount server, a router computer, a personal computer, a portable digital assistant, a mobile phone, a laptop computer, a tablet computer, a netbook, a desktop computer, any combination of the above, or any other such computing device capable of implementing the various features described herein. Management system 100 can be connected to and/or otherwise in communication with various other devices such as administrator device 102 and/or systems ‘A’ and ‘B’ 114A-B, such as via a network (e.g., LAN, WAN, etc.). The management system 100 can include hardware components such as one or more physical processing devices (e.g., central processing units (CPUs)), memory, and other hardware components. In one implementation, the management system 100 includes one or more physical devices (not shown), which can be audio/video devices (e.g., video cards, sounds cards), network interface devices, printers, graphics modules, graphics devices, system components (e.g., PCI devices, bridges, ports, buses), etc. It is understood that the management system 100 may include any number of devices.

Administrator device 102 can be a wireless terminals (e.g., smartphones, etc.), personal computers (PC), laptops, tablet computers, or any other computing or communication device that enables one or more users to communicate with and/or otherwise configure the operation of management system 100. In certain implementations the functionality of administrator device 102 can be incorporated within management system 100.

Systems ‘A’ and ‘B’ 114A-B can be various managed systems which can include, for example, one or more servers, computers, devices, etc., and which can be managed centrally (e.g., to partition network storage, etc.) using various commands, processes, etc., such as those that are specific to a particular configuration of the managed system. Examples of such managed systems include, but are not limited to, Red Hat Enterprise Linux, Dell iDRAC, Microsoft Windows systems, OMI, etc.

As described herein, the management system 100 can receive various commands 104 from administrator device 102, such as commands to perform various operations (e.g., partition network storage) in relation to one or more systems 114A, 114B. Such commands can be provided and/or received as one or more scripts (e.g., Python scripts) and can reflect one or more layers of abstraction in relation to a defined protocol such as the CIM protocol. Upon receiving such commands, abstraction conversion engine 106 can process the commands to generate one or more instructions (e.g., the underlying instructions in the CIM protocol that correspond to the commands received from the administrator). Various instances of such instructions (having been converted, for example, into the underlying CIM protocol) can then be further configured with respect to the respective systems 114 to which they are directed, and provided to such systems in order to implement the received commands. Additionally, it should be noted that the referenced scripts can be asynchronous and/or synchronous.

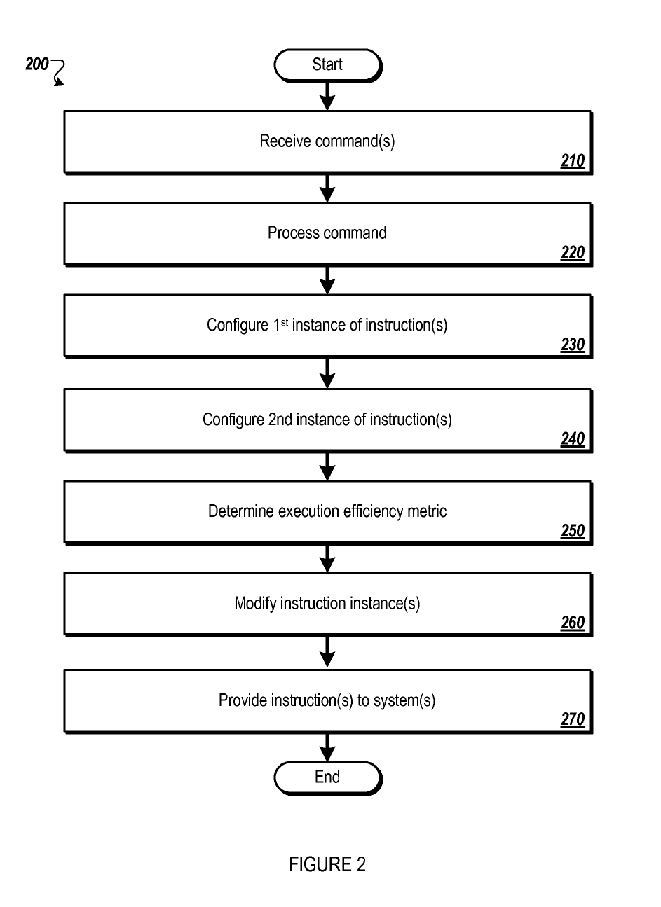

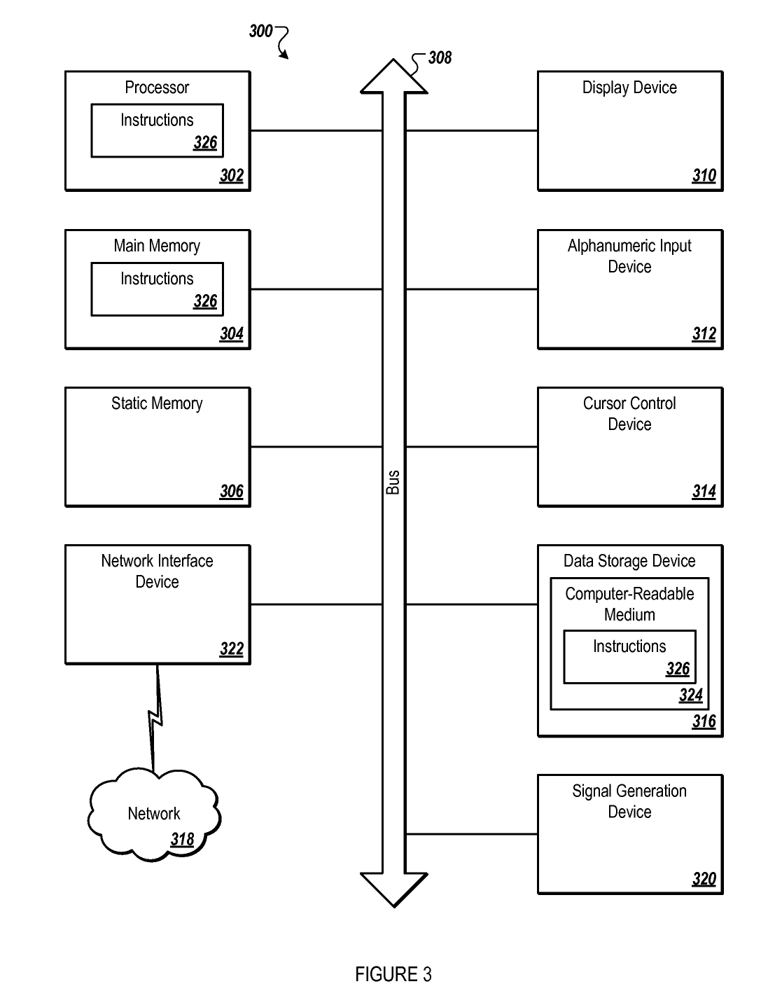

FIG. 2 is a flow diagram of a method 200 for configuring managed systems using abstracted functions in accordance with some implementations. Method 200 can be performed by processing logic (e.g., in computing system 300 of FIG. 3) that may comprise hardware (e.g., circuitry, dedicated logic, programmable logic, microcode, etc.), software (such as instructions run on a processing device), firmware, or a combination thereof. In one implementation, method 200 is performed by abstraction conversion engine 106 and/or management system 100 of FIG. 1. For clarity of presentation, the description that follows uses the system 100 as examples for describing the method 200. However, another system, or combination of systems, may be used to perform the method 200.

At block 210, a command can be received. Such a command can be provided by and/or received (e.g., by abstraction conversion engine 106 and/or management system 100) from an administrator device 102, and can include one or more commands that are directed to one or more managed systems 114 (e.g., a command to partition network storage within a particular managed system). In certain implementations, such command(s) can include one or more scripts (e.g., Python scripts) and can reflect one (or more) layers of abstraction in relation to instructions in a define protocol (e.g., CIM protocol). Moreover, in certain implementations, the received command(s) can correspond to one or more instructions, such as instructions in a defined protocol. That is, it can be appreciated that one or more scripts can be composed which, in turn, can correspond to multiple underlying instructions (which can reflect, for example, the various underlying operations to be performed in order to achieve the provided command). For example, a single command (e.g., a script) to create a RAID array in a particular managed system can actually correspond to several underlying instructions and/or operations to be performed within the system in order to create the RAID array.

Moreover, in certain implementations, the referenced instructions (e.g., the underlying instructions that correspond to the received command) can be directed to multiple managed systems. For example, it can be appreciated that, with respect to a command to partition 1 gigabyte of network storage in every connected managed system, such underlying instructions are directed to each connected system (e.g., system ‘A’ 114A and system ‘B’ 114B, as depicted in FIG. 1).

At block 220, the command (such as that received at block 210) can be processed. In doing so, one or more instructions (such as those that the command corresponds to) can be generated. That is, the received command (which, as noted, can be provided with varying levels of abstraction in relation to a defined protocol such as CIM) can be processed (e.g., by abstraction conversion engine 106 and/or management system 100), such as in relation to protocol data 108. Such protocol data 108 can be a database, for example, which can include the various instructions (e.g., in the CIM protocol) that underlie the received command(s). For example, with respect to a command to partition network storage in a managed system, protocol data 108 can include multiple underlying instructions/operations that are to be performed by a particular system in order to achieve the result or objective indicated in the command (e.g., partition storage). By way of illustration, the various instructions generated (e.g., based on the received command) can correspond to operations to associate one object model with another object model, such as in order to partition network storage, create a RAID array, etc.

At block 230, a first instance of the one or more instructions (such as those generated at block 220) can be configured (e.g., by abstraction conversion engine 106 and/or management system 100). In certain implementations, such an instance of the instructions can be configured with respect to the first system. That is, while the received command can be processed in order to generate various instructions (e.g., in the CIM protocol), it can be appreciated that respective managed systems (e.g., 114A and 114B) can implement variations on such a protocol (e.g., CIM-XML, WS-MAN, etc.). Accordingly, having generated the instructions that underlie the received command, such instructions can be further configured (e.g., by adding, removing, modifying, etc., various aspects of the syntax of the instructions) in order to ensure that such instructions are compatible with the managed system to which they are directed. In certain implementations, such a configuration can be performed in conjunction with system data 110A-110B which can be maintained by management system 100. Such system data can reflect the specifics of a particular protocol (e.g., CIM) as implemented with respect to a particular system (e.g. system ‘A,’ system B,′ etc.).

At block 240, a second instance of the one or more instructions (such as those generated at block 220) can be configured (e.g., by abstraction conversion engine 106 and/or management system 100). In certain implementations, such an instance of the instructions can be configured with respect to the second system. That is, as described in relation to block 230, the instructions that underlie a received command can be further configured to ensure compatibility with various managed system(s), such as in a scenario in which a single command (and/or a single set of underlying instruction(s)) is directed to multiple managed systems, each of which may implement the protocol in a different way.

At block 250, an execution efficiency metric can be determined (e.g., by abstraction conversion engine 106 and/or management system 100). In certain implementations, such an execution efficiency metric can be determined with respect to the first instance of the instructions (such as that configured at block 230) and the second instance of the instructions (such as that configured at block 240). That is, it can be appreciated that, with respect to certain commands (such as those received at block 210), it may be possible to perform the underlying instructions with respect to multiple systems (e.g., a command to partition a certain amount of storage space can be performed in any number of systems). Moreover, given that the command is received having various layers of abstraction applied, the command itself may not define the particular system to which it is directed. Accordingly, in such scenarios an execution efficiency metric can be determined. In certain implementations, such an update efficiency metric can be determined by simulating the execution of the underlying instruction(s) by the respective system and/or by analyzing one or more aspects of the instructions and/or the system (e.g., specifications of a particular system). Moreover, in certain implementations such an execution efficiency metric can reflect an amount of time (e.g., in milliseconds, seconds, etc.) and/or processing power (and/or any other resource overhead) that executing such instructions by a particular system is likely to entail. Moreover, in certain implementations, an efficiency metric of an execution of one instance of the underlying instructions by one system (e.g., instructions 112A by system 114A) can be compared with an efficiency metric of an execution of another instance of the instructions by another system (e.g., instructions 112B by system 114B). In doing so, the system that is capable of executing the underlying instruction(s) relatively more efficiently can be identified.

At block 260, the first instance of the instructions (such as that configured at block 230) and/or the second instance of the one or more instructions (such as that configured at block 240) can be modified (e.g., by abstraction conversion engine 106 and/or management system 100). In certain implementations, such instructions can be modified in view of the execution efficiency metric (such as that determined at block 250). For example, in a scenario in which it is determined that each system can execute the underlying instructions with relatively comparable degrees of efficiency, it may be advantageous to modify various aspects of the underlying instruction in order to distribute aspects of the execution of the instruction across multiple systems (as opposed to executing the instruction at only one system). For example, upon determining that each of system 114A and 114B have comparable execution efficiency metric with respect to a set of instructions to partition 2 GB of storage, the underlying instructions can be modified to direct each system to partition 1 GB of storage, thereby enabling the systems to operate in parallel and achieve further efficiencies.

At block 270, the first instance of the instructions can be provided to the first system and/or the second instance of the instructions can be provided to the second system. In certain implementations, such instruction(s) can be provided (e.g., by abstraction conversion engine 106 and/or management system 100) based on/in view of an execution efficiency metric (such as that computed at block 260). Moreover, as noted, in certain implementations (such as when an instruction is directed to multiple systems), a first instance of the instructions can be provided to a first system and a second instance of the instructions can be provided to a second system.

FIG. 3 is a schematic diagram that shows an example of a machine in the form of a computer system 300. The computer system 300 executes one or more sets of instructions 326 that cause the machine to perform any one or more of the methodologies discussed herein. The machine may operate in the capacity of a server or a client machine in client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions 326 to perform any one or more of the methodologies discussed herein.

The computer system 300 includes a processor 302, a main memory 304 (e.g., read-only memory (ROM), flash memory, dynamic random access memory (DRAM) such as synchronous DRAM (SDRAM) or Rambus DRAM (RDRAM), etc.), a static memory 306 (e.g., flash memory, static random access memory (SRAM), etc.), and a data storage device 316, which communicate with each other via a bus 308.

The processor 302 represents one or more general-purpose processing devices such as a microprocessor, central processing unit, or the like. More particularly, the processor 302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 302 may also be one or more special-purpose processing devices such as an application specific integrated circuit (ASIC), a field programmable gate array (FPGA), a digital signal processor (DSP), network processor, or the like. The processor 302 is configured to execute instructions of the host computer system 100 for performing the operations and steps discussed herein.

The computer system 300 may further include a network interface device 322 that provides communication with other machines over a network 318, such as a local area network (LAN), an intranet, an extranet, or the Internet. The computer system 300 also may include a display device 310 (e.g., a liquid crystal display (LCD) or a cathode ray tube (CRT)), an alphanumeric input device 312 (e.g., a keyboard), a cursor control device 314 (e.g., a mouse), and a signal generation device 320 (e.g., a speaker).

The data storage device 316 may include a computer-readable storage medium 324 on which is stored the sets of instructions 326 of the host computer system 100 embodying any one or more of the methodologies or functions described herein. The sets of instructions 326 of the host computer system 100 may also reside, completely or at least partially, within the main memory 304 and/or within the processor 302 during execution thereof by the computer system 300, the main memory 304 and the processor 302 also constituting computer-readable storage media. The sets of instructions 326 may further be transmitted or received over the network 318 via the network interface device 322.

While the example of the computer-readable storage medium 324 is shown as a single medium, the term “computer-readable storage medium” can include a single medium or multiple media (e.g., a centralized or distributed database, and/or associated caches and servers) that store the sets of instructions 326. The term “computer-readable storage medium” can include any medium that is capable of storing, encoding or carrying a set of instructions for execution by the machine and that cause the machine to perform any one or more of the methodologies of the present disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, it is appreciated that throughout the description, discussions utilizing terms such as “receiving”, “processing”, “configuring”, “determining”, “modifying”, “providing”, or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same implementation unless described as such.

It is to be understood that the above description is intended to be illustrative, and not restrictive. Other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving a command, the command corresponding to one or more instructions in a defined protocol, the one or more instructions being directed to a first system and a second system;
processing the command to generate the one or more instructions;
configuring a first instance of the one or more instructions with respect to the first system;
configuring a second instance of the one or more instructions with respect to the second system;
determining, with a processing device, an execution efficiency metric with respect to the first instance of the one or more instructions and the second instance of the one or more instructions; and
providing, in view of the execution efficiency metric, at least one of the first instance of the one or more instructions to the first system or the second instance of the one or more instructions to the second system.

2. The method of claim 1, wherein determining an execution efficiency metric comprises comparing an efficiency metric of an execution of the first instance of the one or more instructions by the first system with an efficiency metric of an execution of the second instance of the one or more instructions by the second system.

3. The method of claim 1, wherein the defined protocol comprises a Common Information Model (CIM) protocol.

4. The method of claim 1, wherein the command comprises a Python script.

5. The method of claim 1, wherein processing the command comprises processing the command to associate a first object model with a second object model.

6. The method of claim 1, wherein providing at least one of the first instance of the one or more instructions to the first system or the second instance of the one or more instructions to the second system comprises providing the first instance of the one or more instructions to the first system and the second instance of the one or more instructions to the second system.

7. The method of claim 1, further comprising modifying, in view of the execution efficiency metric, at least one of the first instance of the one or more instructions to the first system or the second instance of the one or more instructions to the second system.

8. A system comprising:
a memory; and
a processing device, coupled to the memory, to:
receive a command, the command corresponding to one or more instructions in a defined protocol, the one or more instructions being directed to a first system and a second system;
process the command to generate the one or more instructions;
configure a first instance of the one or more instructions with respect to the first system;
configure a second instance of the one or more instructions with respect to the second system;
determine an execution efficiency metric with respect to the first instance of the one or more instructions and the second instance of the one or more instructions; and
provide, in view of the execution efficiency metric, at least one of the first instance of the one or more instructions to the first system or the second instance of the one or more instructions to the second system.

9. The system of claim 8, wherein to determine an execution efficiency metric is to compare an efficiency metric of an execution of the first instance of the one or more instructions by the first system with an efficiency metric of an execution of the second instance of the one or more instructions by the second system.

10. The system of claim 8, wherein the defined protocol comprises a Common Information Model (CIM) protocol.

11. The system of claim 8, wherein the command comprises a Python script.

12. The system of claim 8, wherein to process the command is to process the command to associate a first object model with a second object model.

13. The system of claim 8, wherein to provide at least one of the first instance of the one or more instructions to the first system or the second instance of the one or more instructions to the second system is to provide the first instance of the one or more instructions to the first system and the second instance of the one or more instructions to the second system.

14. The system of claim 8, wherein the processing device is further to modify, in view of the execution efficiency metric, at least one of the first instance of the one or more instructions to the first system or the second instance of the one or more instructions to the second system.

15. A non-transitory computer-readable storage medium having instructions that, when executed by a processing device, cause the processing device to perform operations comprising:
receiving a command, the command corresponding to one or more instructions in a defined protocol, the one or more instructions being directed to a first system and a second system;
processing the command to generate the one or more instructions;
configuring a first instance of the one or more instructions with respect to the first system;
configuring a second instance of the one or more instructions with respect to the second system;
determining, with the processing device, an execution efficiency metric with respect to the first instance of the one or more instructions and the second instance of the one or more instructions; and
providing, in view of the execution efficiency metric, at least one of the first instance of the one or more instructions to the first system or the second instance of the one or more instructions to the second system.

16. The non-transitory computer-readable storage medium of claim 15, wherein determining an execution efficiency metric comprises comparing an efficiency metric of an execution of the first instance of the one or more instructions by the first system with an efficiency metric of an execution of the second instance of the one or more instructions by the second system.

17. The non-transitory computer-readable storage medium of claim 15, wherein the defined protocol comprises a Common Information Model (CIM) protocol.

18. The non-transitory computer-readable storage medium of claim 15, wherein processing the command comprises processing the command to associate a first object model with a second object model.

19. The non-transitory computer-readable storage medium of claim 15, wherein providing at least one of the first instance of the one or more instructions to the first system or the second instance of the one or more instructions to the second system comprises providing the first instance of the one or more instructions to the first system and the second instance of the one or more instructions to the second system.

20. The non-transitory computer-readable storage medium of claim 15, further comprising modifying, in view of the execution efficiency metric, at least one of the first instance of the one or more instructions to the first system or the second instance of the one or more instructions to the second system.
